(19) United States
(12) Patent Application Publication
(10) Pub. No.: US 2005/0168768 A1
(43) Pub. Date: Aug. 4, 2005

(54) Information processing apparatus and method, and program product

(75) Inventor: Morikazu Ito, Milsons Point NSW (AU)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/018,230

(22) Filed: Dec. 22, 2004

(30) Foreign Application Priority Data
Dec. 26, 2003 (JP) 2003-435454

(51) Int. Cl. G06F 15/00; G06F 3/12

(52) U.S. Cl. 358/1.14

(57) ABSTRACT

An information processing apparatus includes a determination unit for determining if a warning corresponding to print data is present, an input unit for inputting information, and an output unit for, when the determination unit determines that the warning corresponding to the print data is present, outputting a different message on the basis of environment information input by the input unit.

### FIELD OF THE INVENTION

The present invention relates to an information processing apparatus and method, and a program product.

### BACKGROUND OF THE INVENTION

Conventionally, a preflight check process for checking the validity of print data is executed before print data is printed. For example, Japanese Patent Laid-Open No. 2003-276150 discloses a process for confirming whether or not prepress processes can be executed without any problems by analyzing the contents of print data. For example, the presence/absence of object files having links in a document, the presence/absence of non-standard font data in the document, and the like are confirmed on the basis of the description of a PDF file or PostScript file. If some data or files are missing, the process requests the user to add data or give a specification.

However, the conventional technique merely compares a document that records elements in question with print data to display a predetermined warning message. For example, that technique cannot display more detailed warning messages and solutions on the basis of the conditions of a printer as an output destination and other output environments (e.g., an outputtable paper size, finishing conditions, and the like in case of the printer; font data, ICC profile data, and the like in other output environments). Therefore, in case of print data that may pose a problem upon printout, whether the problem is caused by print data itself or the output environment (e.g., a printer, host computer, or the like) cannot be distinguished, and appropriate correction cannot be made based on warning messages and solutions in the preflight check process.

Also, a document creator may be different from an operator that operates a document and prints it out at a printer. Furthermore, user locations and their operation abilities may be different. However, appropriate messages cannot be generated and informed in correspondence with these cases.

### SUMMARY OF THE INVENTION

The present invention has been made in consideration of the above situation, and has as its object to check the validity of print data with higher precision.

The first aspect of the present invention relates to an information processing apparatus comprising: a determination unit for determining if a warning corresponding to print data is present; an input unit for inputting information; and an output unit for, when the determination unit determines that the warning corresponding to the print data is present, outputting a different message on the basis of environment information input by the input unit.

The second aspect of the present invention relates to an information processing method comprising: a determination step of determining if a warning corresponding to print data is present; an input step of inputting information; and an output step of outputting, when it is determined in the determination step that the warning corresponding to the print data is present, a different message on the basis of environment information input in the input step.

The third aspect of the present invention relates to a program product comprising: a determination step of determining if a warning corresponding to print data is present; an input step of inputting information; and an output step of outputting, when it is determined in the determination step that the warning corresponding to the print data is present, a different message on the basis of environment information input in the input step.

According to the present invention, the validity of print data can be checked with higher precision.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a schematic block diagram showing the arrangement of an information processing apparatus according to the first preferred embodiment of the present invention;

FIG. 2 shows the recording contents of an FD or CD-ROM;

FIG. 3 shows a memory map of the information processing apparatus according to the first preferred embodiment of the present invention;

FIG. 4 is a flowchart showing a preflight check process according to the first and second preferred embodiments of the present invention;

FIG. 5 is a flowchart showing a preflight check process according to the first and second preferred embodiments of the present invention;

FIG. 6 is a flowchart showing a preflight check process according to the first and second preferred embodiments of the present invention;

FIG. 7 is a flowchart showing a preflight check process according to the first and second preferred embodiments of the present invention;

FIG. 8 is a flowchart showing a preflight check process according to the first and second preferred embodiments of the present invention;

FIG. 9 is a schematic view showing the arrangement of a preflight check system according to the second preferred embodiment of the present invention; and

FIGS. 10A and 10B are schematic views of tables that associate various kinds of information, warning messages, and solutions.

### DETAILED DESCRIPTION OF THE PREFERRED EMBODIMENTS

The preferred embodiments of the present invention will be described hereinafter with reference to the accompanying drawings.

### First Embodiment

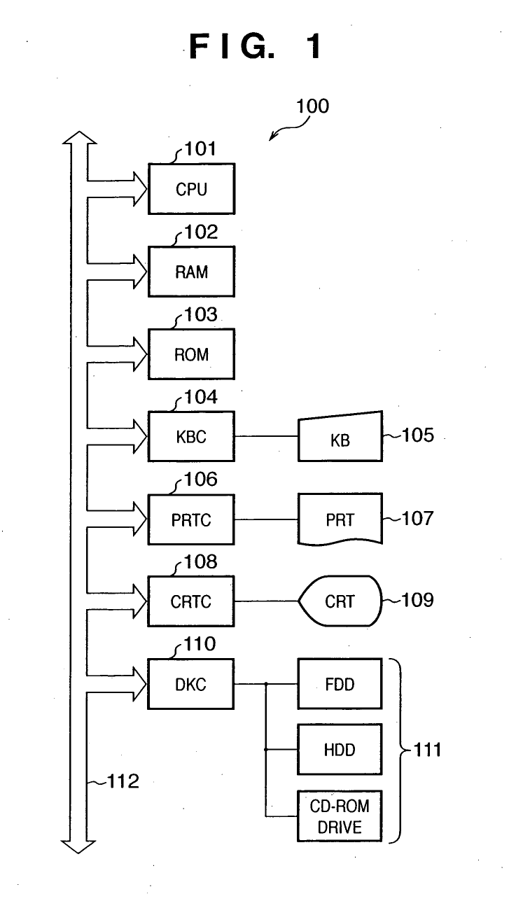

FIG. 1 is a block diagram showing the basic arrangement of an information processing apparatus 100 according to the first preferred embodiment of the present invention.

Referring to FIG. 1, a CPU (central processing unit) 101 performs control and arithmetic processes of the overall apparatus. A RAM (random-access memory) 102 includes memory areas used to load and execute programs and data for respective processes. A ROM (read-only memory) 103 has memory areas including a system control program, input PDL (Page Description Language), intermediate PDL, image data, ID (Identification) table, and the like. A KBC (keyboard controller) 104 is a controller which receives data from a KB (keyboard) 105 by means of key inputs, and transfers them to the CPU 101. A PRTC (printer controller) 106 is a controller for controlling a PRT (printer) 107. The printer 107 is an output device including a laser beam printer, ink-jet printer, or the like. A CRTC (display controller) 108 is a controller that controls display on a CRT (display) 109. A DKC (disk controller) 110 is a controller for controlling data transfer and the like with an external storage device 111. The external storage device 111 includes an FDD (floppy® disk drive), HDD (hard disk drive), CD (CD-ROM) drive, and the like. The external storage device 111 stores programs and data, and refers to or loads programs and data onto the RAM 102 as needed upon executing the programs. A system bus 112 serves as a data transfer path among the aforementioned components. A program that displays preflight check messages in correspondence with users is installed in the HDD 111.

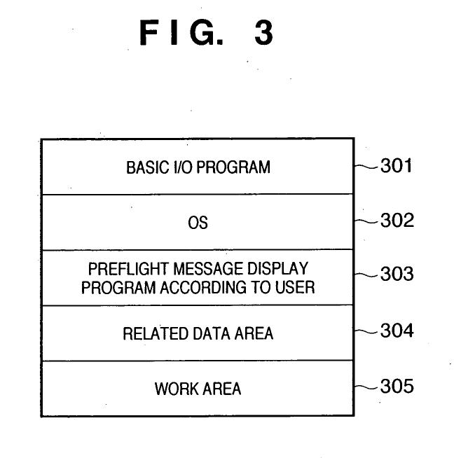

FIG. 3 schematically shows a memory map when the program that displays preflight check messages is ready to run in the HDD 111. Reference numeral 301 denotes a basic I/O (input/output) program used to input/output data and the like. Reference numeral 302 denotes an OS (operating system) that manages various programs and peripheral devices and the like. Reference numeral 303 denotes a program used to display preflight check messages in correspondence with users. Reference numeral 304 denotes a related data area which includes related data (e.g., print data, environment information, and a table that associates these kinds of information, warning messages, and solutions, and the like) used in the information processing apparatus 100 in FIG. 1. Reference numeral 305 denotes a work area temporarily used when a preflight check process or the like is executed.

The basic I/O program 301 is stored in, e.g., the ROM 103 in FIG. 1. The OS 302 is written in, e.g., the HDD 111 in FIG. 1. When the power switch of the information processing apparatus shown in FIG. 1 is turned on, the OS 302 stored in the HDD 111 is loaded onto the RAM 102 by an IPL (initial program loading) function of the basic I/O program 301, and the operation of the OS 302 starts.

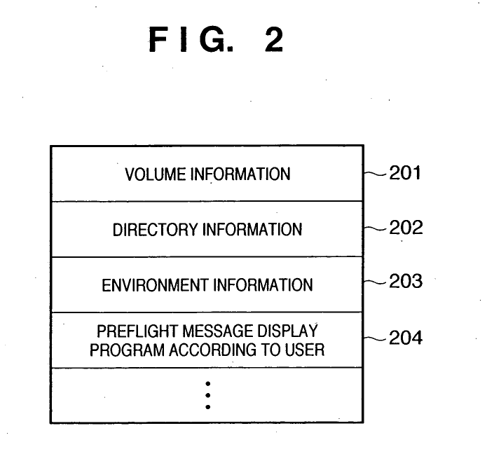

FIG. 2 schematically shows the recording contents of an FD or CD-ROM which stores a program for displaying preflight messages and related data. Reference numeral 201 denotes volume information associated with the FD or CD-ROM. Reference numeral 202 denotes directory information including a directory structure and the like. Reference numeral 203 denotes a related data area which includes related data (e.g., print data, environment information, and a table that associates these kinds of information, warning messages, and solutions, and the like) used in the information processing apparatus 100 in FIG. 1. Reference numeral 204 denotes a program for displaying preflight messages in correspondence with users.

As shown in FIG. 2, an FD or CD-ROM that stores the related data 203 and program 204 is inserted into the FDD or CD-ROM drive 111, and can be installed in the HDD 111 of this apparatus. In this case, when the FD or CD-ROM is set in the FDD or CD-ROM 111, the related data 203 and program 204 are read out from the FDD or CD-ROM drive 111 and are installed in the HDD 111 under the control of the OS 302 and basic I/O program 301 shown in FIG. 3, so that they are ready to run.

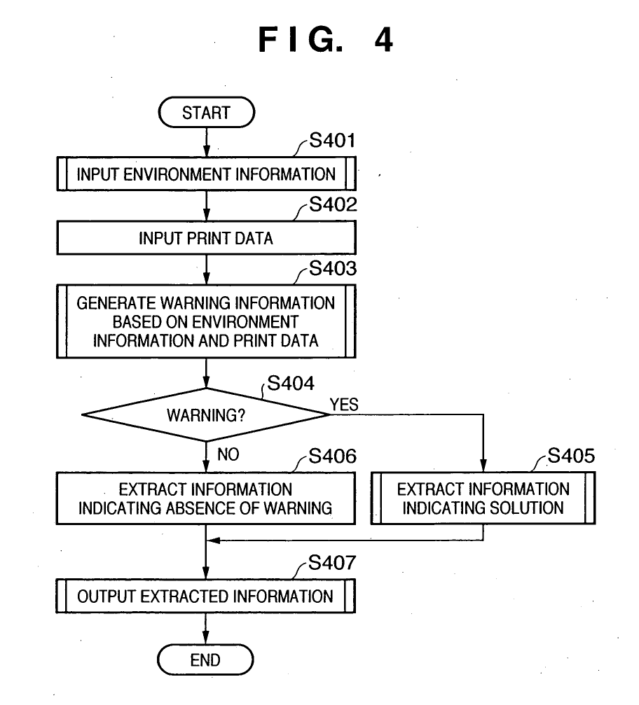

FIG. 4 is a flowchart showing a preflight check process of print data in the information processing apparatus 100 shown in FIG. 1 according to this embodiment.

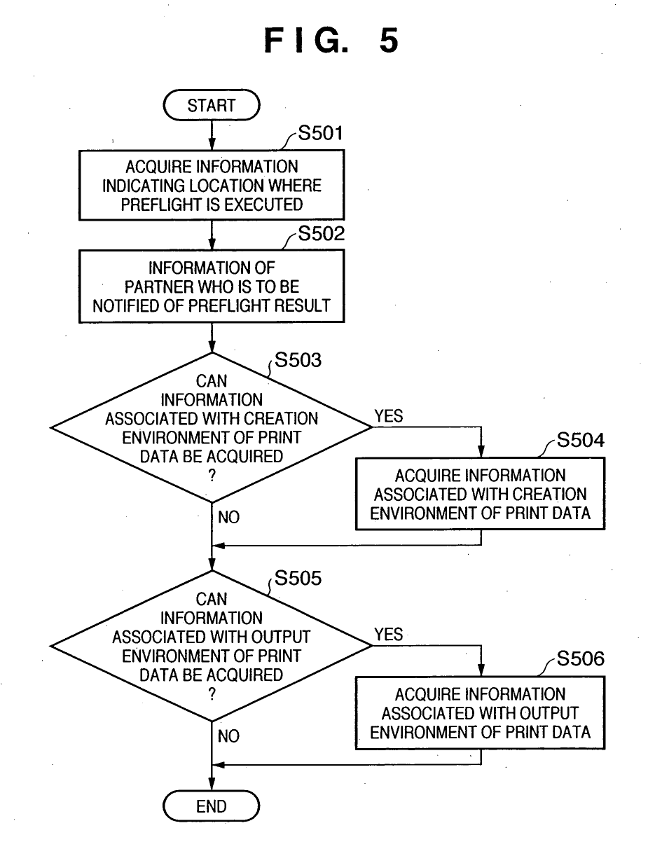

In step S401, environment information associated with input print data (e.g., including a preflight check location (a location where the preflight check process is to be executed), the user name as a partner to whom the preflight check result is sent, the location of the user, the user ability, generation environment information of print data to be printed, output environment information of print data to be printed, and the like is input. Details of the process in step S401 will be described later with reference to the flowchart in FIG. 5.

In step S402, print data (e.g., PDF or the like) which is to undergo the preflight check process and the program 204 are input from the FDD or CD-ROM drive 111 shown in FIG. 1. This program 204 becomes ready to run after it is installed on the HDD 111 (corresponding to 303 in the memory map shown in FIG. 3). The CPU 101 shown in FIG. 1 controls to interpret the input print data in accordance with the program 303 installed on the HDD 111 to acquire document information such as color, font, and the like, and to store that information in the HDD 111.

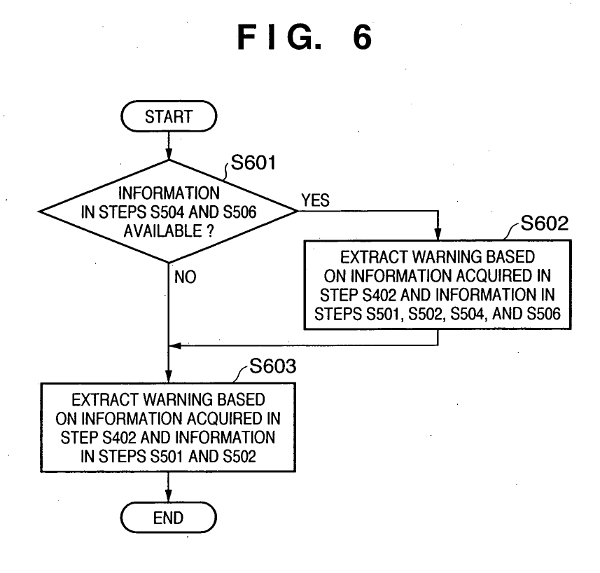

In step S403, the CPU 101 shown in FIG. 1 executes a preflight check process in accordance with the program 303 in FIG. 3. More specifically, the CPU 101 reads out the print data and environment information stored in steps S401 and S402, and generates warning information corresponding to them. Details of the process in step S403 will be described later with reference to the flowchart in FIG. 6.

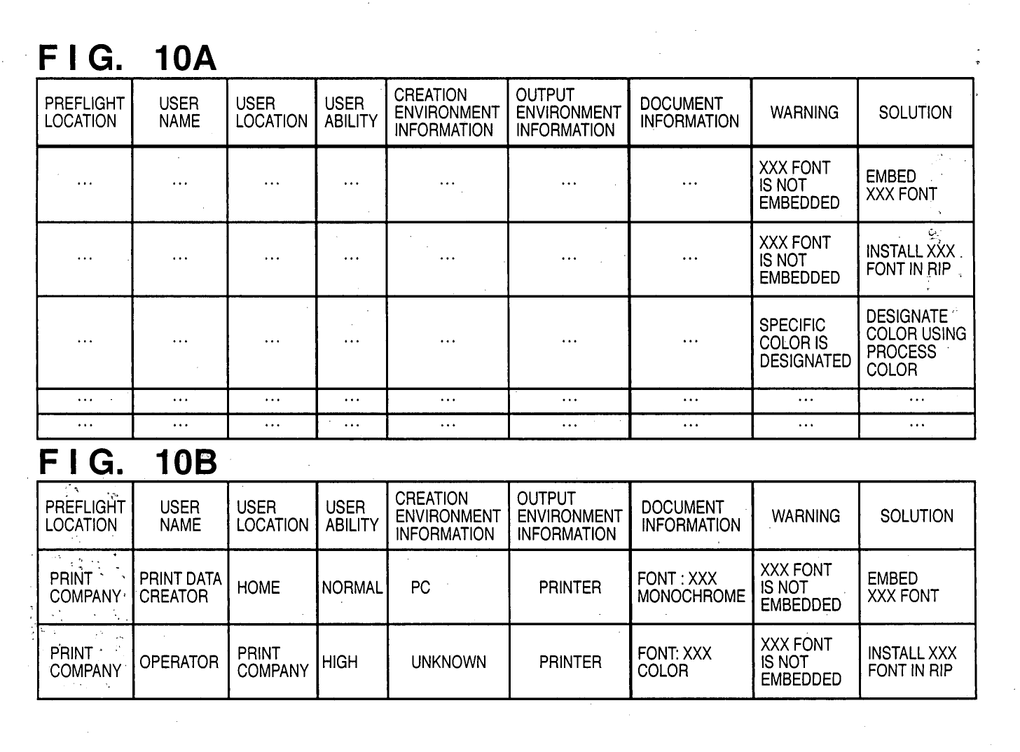

In step S404, the CPU 101 shown in FIG. 1 compares the warning information generated in step S403 in FIG. 4 with a table (see FIG. 10A) which is pre-stored in the HDD 111 and has warning information, in accordance with the program 303 in FIG. 3, to check if at least one of the print data and environment information includes warning information. If it is determined that at least one of the print data and environment information includes warning information (YES in step S404), the flow advances to step S405; otherwise (NO in step S404), the flow advances to step S406. Assume that three warnings are found for a print data creator, and two warnings for an operator.

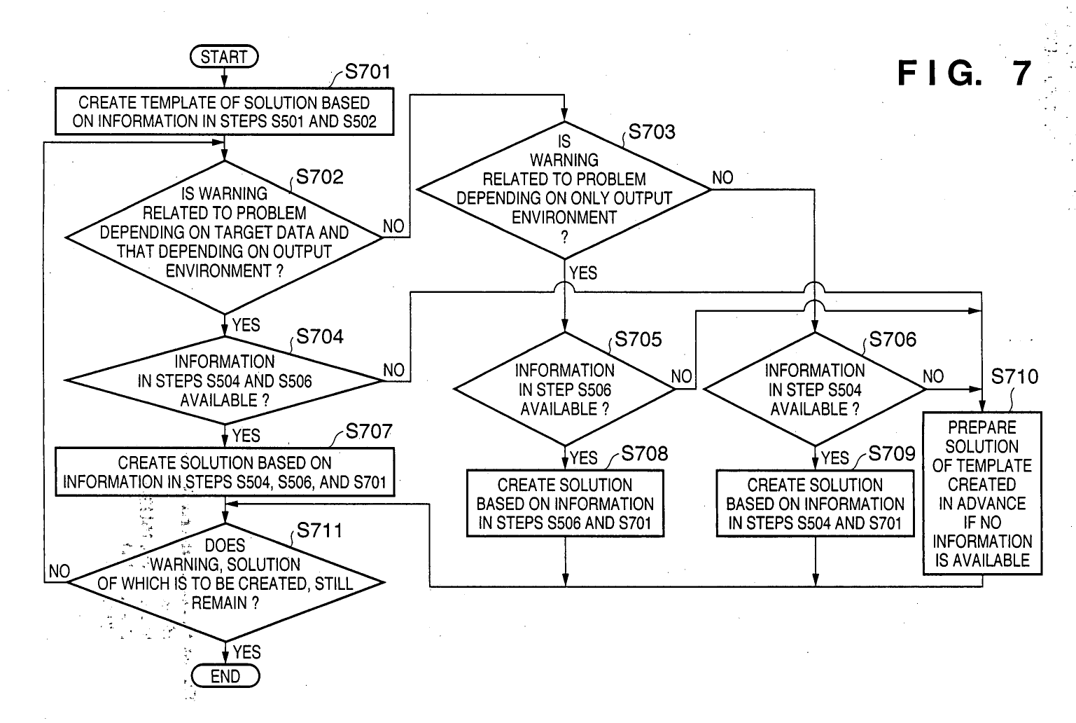

In step S405, the CPU 101 shown in FIG. 1 generates information indicating solutions for the warnings found in step S404 in FIG. 4 in correspondence with the print data and environment information in accordance with the program 303 in FIG. 3. Details of the process in step S405 will be described later with reference to the flowchart in FIG. 7.

In step S406, the CPU 101 in FIG. 1 generates information indicating no warning for the print data and environment information in accordance with the program 303 in FIG. 3.

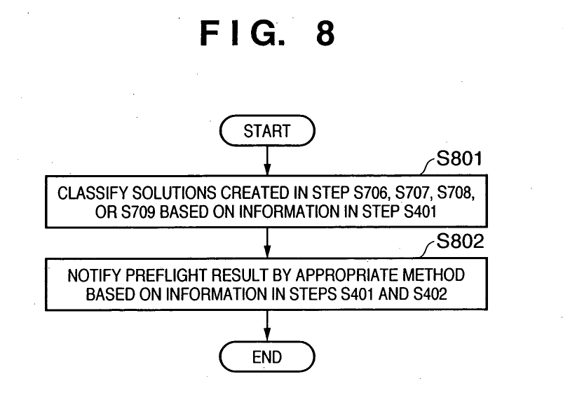

In step S407, the CPU 101 in FIG. 1 outputs the information extracted in step S405 or S406 in FIG. 4. Details of the process in step S407 will be described later with reference to the flowchart in FIG. 8.

FIG. 5 is a flowchart showing the preflight check process in FIG. 4 in more detail. Steps S501 to S506 to be described below exemplify a detailed practical example of step S401.

In step S501, information indicating the location where the preflight check process is to be executed is acquired. For example, if the running preflight check program is the one for a client (since it is normally used by an operator), an output base (a location where the print process is made) can be obtained as the location where the preflight check process is to be executed. On the other hand, if the running preflight check program is the one for a server (since it is normally used by a print data creator), a printing order server (a location where data is to be uploaded (entered)) can be obtained as the location where the preflight check process is to be executed. The preflight check process can confirm whether or not the location where the preflight check process is to be executed is the same as that where the print process is made (is the same as the output base). In this embodiment, the information processing apparatus 100 in FIG. 1 executes the preflight check process, and the PRT 107 connected to the information processing apparatus 100 performs a print process. Hence, assume that the location where the preflight check process is executed is the same as that where the print process is executed.

In step S502, information of a partner who is to be notified of the preflight check result is acquired. For example, if the running preflight check program is the one for a server, information of the print data creator can be acquired as the partner who is to be notified of the preflight check result; if the running preflight check program is the one for a client, information of the operator can be acquired as the partner who is to be notified of the preflight check result. On the other hand, a user ID may be registered in advance, and the partner who is to be notified of the preflight check result may be specified based on this user ID. In this way, the partner who is to be notified of the preflight check result can be recognized. In this embodiment, information of the print data creator (who is physically separated from the PRT 107 and can operate the print data but cannot make any print operation) and information of the operator who performs the print process (which is located at the PRT 107 where the preflight check process is executed, and can make the print operation at the PRT 107 but cannot change the print data) are acquired.

It is checked in step S503 if creation environment information of print data (e.g., information associated with an output device, interpreter, rendering, and the like) can be acquired before the preflight check process. If the creation environment information of print data can be acquired (YES in step S503), the flow advances to step S504; otherwise (NO in step S503), the flow advances to step S505. In this embodiment, assume that an environment where print data is created is separated from the information processing apparatus 100, and the creation environment information of print data cannot be acquired (NO in step S503).

In step S504, the creation environment information of print data is acquired. For example, environment information of a font, profile, and the like can be acquired by inquiring the operating system or checking a specific folder.

It is checked in step S505 if output environment information of print data (e.g., information associated with an output device, interpreter, rendering, and the like) can be acquired when the information processing apparatus 100 executes the preflight check process of print data. If it is determined that the output environment information of print data can be acquired (YES in step S505), the flow advances to step S506; otherwise (NO in step S505), the process ends. Assume that the output environment information can be acquired since the information processing apparatus 100 that executes the preflight check process and the PRT 107 that performs the print process are at the same location.

In step S506, the output environment information of print data is acquired. For example, environment information of a font of the printer, and the like can be acquired by inquiring the printer, printer driver, or the like.

FIG. 6 is a flowchart showing the preflight check process in FIG. 4 in more detail. Steps S601 to S603 to be described below exemplify a detailed practical example of step S403.

It is checked in step S601 if the creation environment information in step S504 and the output environment information in step S506 are available. If it is determined that these pieces of information are available (YES in step S601), the flow advances to step S602; otherwise (NO in step S601), the flow advances to step S603. In this case, since it is determined in step S503 that the creation environment information cannot be acquired, only the output environment information acquired in step S506 is available. Hence, the flow advances to step S603.

In step S602, the document information in step S402 and the information in steps S501, S502, S504, and S506 are acquired, and warnings corresponding to these pieces of information are extracted on the basis of the table (see FIG. 10A) which is stored in advance in the HDD 111 in FIG. 1 and associates these pieces of information with the warnings and solutions. Note that FIG. 10A illustrates one table, but a plurality of tables may be used in association with each other using a relational database.

In step S603, the document information in step S402 and the information in steps S501 and S502 are acquired, and warnings corresponding to these pieces of information are extracted on the basis of the table (see FIG. 10A) which is stored in advance in the HDD 111 in FIG. 1 and associates these pieces of information with the warnings and solutions.

FIG. 7 is a flowchart showing the preflight check process in FIG. 4 in more detail. Steps S701 to S711 to be described below exemplify a detailed practical example of step S405.

Steps S701 to S711 form a loop which is repeated in correspondence with the number of warnings.

In step S701, the two pieces of information in steps S501 and S502 are acquired, and a solution corresponding to these pieces of information is extracted on the basis of the table (see FIG. 10A) which is stored in advance in the HDD 111 in FIG. 1 and associates these pieces of information with the warnings and solutions, thus creating a solution template. The created template is stored in the HDD 111.

It is checked in step S702 if the warning extracted in step S602 or S603 is a problem which depends on the print data that is to undergo the preflight check process, and depends on its output environment. If it is determined that the warning depends on both the problems (YES in step S702), the flow advances to step S704; otherwise (NO in step S702), the flow advances to step S703. For example, if the warning indicates that a font is not embedded in print data, and may be replaced by another font upon output, that problem can be solved by embedding that font, and also by installing that font in RIP (Raster Image Processor) (i.e., YES in step S702). As another example, if the warning indicates that a specific color is designated in print data and may be replaced by a process color upon output, this problem can be solved by creating the print data using a process color (i.e., NO in step S702).

It is checked in step S703 if the warning extracted in step S602 or S603 is a problem which depends on only the output environment which is to undergo the preflight check process. If the warning depends on only the output environment (YES in step S703), the flow advances to step S705; otherwise (NO in step S703), the flow advances to step S706.

It is checked in step S704 if the creation environment information in step S504 and the output environment information of print data in step S506 are available. If these pieces of information are available (YES in step S704), the flow advances to step S707; otherwise (NO in step S704), the flow advances to step S710.

It is checked in step S705 if the output environment information in step S506 is available. If that information is available (YES in step S705), the flow advances to step S708; otherwise (NO in step S705), the flow advances to step S710.

It is checked in step S706 if the creation environment information in step S504 is available. If that information is available (YES in step S706), the flow advances to step S709; otherwise (NO in step S706), the flow advances to step S710.

In step S707, the two pieces of information in steps S504 and S506 are acquired, and a solution corresponding to these pieces of information is extracted on the basis of the table (see FIG. 10A) which is stored in advance in the HDD 111 in FIG. 1 and associates these pieces of information with the warnings and solutions. Then, a final solution is created in combination with the template created in step S701. For example, “warnings” and “solutions” associated with “creation environment information” and “output environment information” are extracted from the table shown in FIG. 10A in addition to “preflight check location” (location where the preflight check process is to be executed), “user name”, “user location”, and “user ability” acquired in step S701, thus creating a new table shown in FIG. 10B. In this way, for example, as shown in FIG. 10B, a warning “XXX font is not embedded” and a solution “embed XXX font” can be prepared for the print data creator, and a warning “XXX font is not embedded” and a solution “install XXX font in RIP” can be prepared for the operator.

In step S708, the information in step S506 is acquired, and a solution corresponding to this information is extracted on the basis of the table (see FIG. 10A) which is stored in advance in the HDD 111 in FIG. 1 and associates these pieces of information with the warnings and solutions. Then, a final solution is created in combination with the template created in step S701. For example, a message “if printer that can output A0 is available, change to that printer” for the operator is created as a warning for the operator. For example, “warning” and “solution” associated with “output environment information” are extracted from the table shown in FIG. 10A in addition to “preflight check location” (location where the preflight check process is to be executed), “user name”, “user location”, and “user ability” acquired in step S701, thus creating a new table (not shown).

In step S709, the information in step S504 is acquired, and a solution corresponding to this information is extracted on the basis of the table (see FIG. 10A) which is stored in advance in the HDD 111 in FIG. 1 and associates these pieces of information with the warnings and solutions. Then, a final solution is created in combination with the template created in step S701. For example, “warning” and “solution” associated with “creation environment information” are extracted from the table shown in FIG. 10A in addition to “preflight check location” (location where the preflight check process is to be executed), “user name”, “user location”, and “user ability” acquired in step S701, thus creating a new table (not shown).

In step S710, a solution of the template created in advance in step S701 is read out from the HDD 111 since no information is available in steps S504 and S506. For example, if a warning for the process color is extracted, a solution that advises the print data creator to designate a color using the process color can be prepared for the print data creator.

It is checked in step S711 if warnings, solutions of which are to be created, still remain, i.e., if solutions have been prepared for all warnings. If NO in step S711, the flow returns to step S702; otherwise, the process ends.

FIG. 8 is a flowchart showing the preflight check process in FIG. 4 in more detail. Steps S801 and S802 to be described below exemplify a detailed practical example of step S407.

In step S801, the solutions created in step S707, S708, S709, or S710 are classified for users to be notified on the basis of the environment information acquired in step S401, and warnings according to these users to be notified are extracted.

In step S802, a preflight check result is output by an appropriate method on the basis of the environment information acquired in step S401 and the print data acquired in step S402. For example, a UI of the preflight check application can be sent to the operator, and the warnings and solutions can be sent to the print data creator via an e-mail message.

With the above processes, a preflight check process with high precision can be made in consideration of the device setting condition, the creation environment information of preflight check data, information of an interpreter, RIP, and printout, and the like.

If warnings are extracted, different messages can be prepared in correspondence with partners who are to be notified of the warnings and solutions, and the user who receives the preflight check result can easily understand the contents.

### Second Embodiment

In the second preferred embodiment of the present invention, a method of uploading print data to a server, and executing a preflight check process on that server to output warnings and solutions corresponding to users will be described in detail hereinafter.

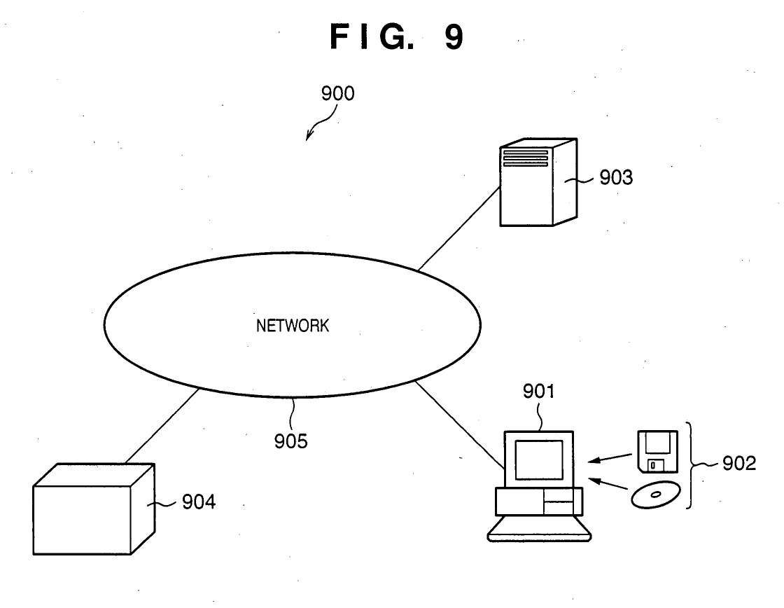

FIG. 9 is a schematic view showing the arrangement of a preflight check system 900 for checking the validity of print data according to this embodiment. The preflight check system 900 includes a client 901 which receives print data and the like from a recording medium 902 such as a FD, CD-ROM, and the like, a server 903 which executes a preflight check process of print data, a printing device 904 such as a printer which prints print data, and a network 905 which can connect them.

The preflight check system 900 is obtained by modifying some components of the information processing apparatus 100 according to the first embodiment. More specifically, the client 901 comprises the KBC (keyboard controller) 104, KB (keyboard) 105, CRTC (display controller) 108, CRT (display) 109, DKC (disk controller) 110, and external storage device 111 shown in FIG. 1. The server 903 comprises the CPU (central processing unit) 101, RAM (random-access memory) 102, and ROM (read-only memory) 103. The printing device 904 comprises the PRTC (printer controller) and PRT (printer) 107 shown in FIG. 1.

Note that the arrangement of this embodiment is merely an example, and the present invention is not limited to this. For example, if other patterns using networks may be used, the same effect can be obtained.

The preflight check process of this embodiment is substantially the same as the steps of that in the first embodiment. Therefore, a description of the same processes will be omitted, and operations unique to this embodiment will be explained.

In step S501 in FIG. 5, since the preflight check process is done on the server 903, preflight check process related information indicating that the location where the preflight check process is to be executed is that on the server 903 is input.

It is checked in step S505 in FIG. 5 if output environment information of print data (e.g., information associated with an output device, interpreter, rendering, and the like) can be acquired upon executing the preflight check process. In this case, since the location where the preflight check process is to be executed is that on the server 903, and the server 903 can be connected to the printing device 904 that performs a print process via the network 905, output environment information can be acquired (i.e., YES in step S505).

It is checked in step S601 in FIG. 6 if the creation environment information in step S504 and the output environment information in step S506 are available. In this case, if the client 901 corresponds to a creation environment, the creation environment information can also be acquired, and the flow advances to step S602. In step S602, the document information in step S402 and the information in steps S501, S502, S504, and S506 are acquired, and warnings corresponding to these pieces of information are extracted on the basis of the table (see FIG. 10A) which is stored in advance in the HDD 111 in FIG. 1 and associates these pieces of information with the warnings and solutions.

In step S801, the warnings and solutions created in step S707, S708, S709, or S710 are classified for users to be notified on the basis of the environment information acquired in step S401. In this embodiment, when the result is to be sent to the print data creator, the warnings and solutions are classified for the print data creator. For example, warnings according to each user to be notified can be extracted on the basis of the table (see FIG. 10A) that associates the print data creator, warnings, and solutions.

In step S802, a preflight check result is output by an appropriate method on the basis of the environment information acquired in step S401 and the print data acquired in step S402. In this embodiment, warnings and solutions can be sent from the server 903 to the client 901 using, e.g., an e-mail message, via the network 905. As a result, optimal warnings and solutions can be provided to the print data creator.

With the above processes, the network system which includes the server and information processing apparatus that can be connected to the network can execute the preflight check process with higher precision.

### Other Embodiments

The objects of the present invention are also achieved by supplying a storage medium, which records a program code of a software program that can implement the functions of the above-mentioned embodiments to the system or apparatus, and reading out and executing the program code stored in the storage medium by a computer (or a CPU or MPU) of the system or apparatus. In this case, the program code itself read out from the storage medium implements the functions of the above-mentioned embodiments, and the storage medium which stores the program code constitutes the present invention. As the storage medium for supplying the program code, for example, a floppy disk, hard disk, optical disk, magneto-optical disk, CD-ROM, CD-R, magnetic tape, nonvolatile memory card, ROM, and the like may be used.

The functions of the above-mentioned embodiments may be implemented not only by executing the readout program code by the computer but also by some or all of actual processing operations executed by an OS (operating system) running on the computer on the basis of an instruction of the program code.

Furthermore, the functions of the above-mentioned embodiments may be implemented by some or all of actual processing operations executed by a CPU or the like arranged in a function extension board or a function extension unit, which is inserted in or connected to the computer, after the program code read out from the storage medium is written in a memory of the extension board or unit.

As many apparently widely different embodiments of the present invention can be made without departing from the spirit and scope thereof, it is to be understood that the invention is not limited to the specific embodiments thereof except as defined in the claims.

### CLAIM OF PRIORITY

This application claims priority from Japanese Patent Application No. 2003-435454 filed on Dec. 26, 2003, which is hereby incorporated by reference herein.

1. An information processing apparatus comprising:
a determination unit for determining if a warning corresponding to print data is present;
an input unit for inputting information; and
an output unit for, when said determination unit determines that the warning corresponding to the print data is present, outputting a different message on the basis of environment information input by said input unit.

2. The apparatus according to claim 1, wherein the information includes user information.

3. The apparatus according to claim 1, wherein the information includes creation environment information.

4. The apparatus according to claim 1, wherein the information includes output environment information.

5. The apparatus according to claim 1, wherein the message includes a solution.

6. An information processing method comprising:
a determination step of determining if a warning corresponding to print data is present;
an input step of inputting information; and
an output step of outputting, when it is determined in the determination step that the warning corresponding to the print data is present, a different message on the basis of environment information input in the input step.

7. The method according to claim 6, wherein the information includes user information.

8. The method according to claim 6, wherein the information includes creation environment information.

9. The method according to claim 6, wherein the information includes output environment information.

10. The method according to claim 6, wherein the message includes a solution.

11. A program product comprising:
a determination step of determining if a warning corresponding to print data is present;
an input step of inputting information; and
an output step of outputting, when it is determined in the determination step that the warning corresponding to the print data is present, a different message on the basis of environment information input in the input step.

12. The program product according to claim 11, wherein the information includes user information.

13. The program product according to claim 11, wherein the information includes creation environment information.

14. The program product according to claim 11, wherein the information includes output environment information.

15. The program product according to claim 11, wherein the message includes a solution.
